(19) United States
(12) Patent Application Publication
(10) Pub. No.: US 2023/0077816 A1
(43) Pub. Date: Mar. 16, 2023

(54) SOUND SOURCE LOCALIZATION MODEL TRAINING AND SOUND SOURCE LOCALIZATION METHOD, AND APPARATUS

(71) Applicant: BEIJING BAIDU NETCOM SCIENCE TECHNOLOGY CO., LTD., Beijing (CN)

(72) Inventors: Wei Du, Beijing (CN); Saisai Zou, Beijing (CN); Tengyu Du, Beijing (CN)

(73) Assignee: BEIJING BAIDU NETCOM SCIENCE TECHNOLOGY CO., LTD., Beijing (CN)

(21) Appl. No.: 17/658,513

(22) Filed: Apr. 8, 2022

(30) Foreign Application Priority Data
Sep. 13, 2021 (CN) 202111068636.6

(51) Int. Cl. G10L 25/18; G10L 25/87; G06N 3/08

(52) U.S. Cl. CPC G10L 25/18; G10L 25/87; G06N 3/08; G10L 2025/783

(57) ABSTRACT

The present disclosure provides a method for training sound source localization model and a sound source localization method, and relates to the field of artificial intelligence technologies such as voice processing and deep learning. The method for training sound source localization model method includes: obtaining a sample audio according to an audio signal including a wake-up word; extracting an audio feature of at least one audio frame in the sample audio, and marking a direction label and a mask label of the at least one audio frame; and training a neural network model by using the audio feature of the at least one audio frame and the direction label and the mask label of the at least one audio frame, to obtain a sound source localization model. The sound source localization method includes: acquiring a to-be-processed audio signal, and extracting an audio feature of each audio frame in the to-be-processed audio signal; inputting the audio feature of each audio frame into a sound source localization model, to obtain sound source direction information outputted by the sound source localization model for each audio frame; determining a wake-up word endpoint frame in the to-be-processed audio signal; and obtaining a sound source direction of the to-be-processed audio signal according to sound source direction information corresponding to the wake-up word endpoint frame.

The present application claims the priority of Chinese Patent Application No. 202111068636.6, filed on Sep. 13, 2021, with the title of “SOUND SOURCE LOCALIZATION MODEL TRAINING AND SOUND SOURCE LOCALIZATION METHOD, AND APPARATUS”. The disclosure of the above application is incorporated herein by reference in its entirety.

### FIELD OF THE DISCLOSURE

The present disclosure relates to the field of computer technologies, and in particular, to the field of artificial intelligence technologies such as voice processing and deep learning. Sound source localization model training and sound source localization methods and apparatuses, an electronic device and a readable storage medium are provided.

### BACKGROUND OF THE DISCLOSURE

With an increasing demand for voice interaction, more and more attention has been paid to products based on voice interaction. Sound source localization means judging a direction of a sound source relative to an audio acquisition apparatus by analyzing an audio signal collected by the audio acquisition apparatus.

A sound source localization technology is widely used in products and scenarios requiring voice interaction such as intelligent home and intelligent vehicles. However, accuracy and efficiency of sound source localization are relatively low in the prior art during the sound source localization.

### SUMMARY OF THE DISCLOSURE

According to a first aspect of the present disclosure, a method for training sound source localization model is provided, including: obtaining a sample audio according to an audio signal including a wake-up word; extracting an audio feature of at least one audio frame in the sample audio, and marking a direction label and a mask label of the at least one audio frame; and training a neural network model by using the audio feature of the at least one audio frame and the direction label and the mask label of the at least one audio frame, to obtain a sound source localization model.

According to a second aspect of the present disclosure, a sound source localization method is provided, including: acquiring a to-be-processed audio signal, and extracting an audio feature of each audio frame in the to-be-processed audio signal; inputting the audio feature of each audio frame into a sound source localization model, to obtain sound source direction information outputted by the sound source localization model for each audio frame; determining a wake-up word endpoint frame in the to-be-processed audio signal; and obtaining a sound source direction of the to-be-processed audio signal according to sound source direction information corresponding to the wake-up word endpoint frame.

According to a third aspect of the present disclosure, an electronic device is provided, including: at least one processor; and a memory communicatively connected with the at least one processor; wherein the memory stores instructions executable by the at least one processor, and the instructions are executed by the at least one processor to enable the at least one processor to perform a method for training sound source localization model, wherein the method includes: obtaining a sample audio according to an audio signal including a wake-up word; extracting an audio feature of at least one audio frame in the sample audio, and marking a direction label and a mask label of the at least one audio frame; and training a neural network model by using the audio feature of the at least one audio frame and the direction label and the mask label of the at least one audio frame, to obtain a sound source localization model.

According to a fourth aspect of the present disclosure, there is provided a non-transitory computer readable storage medium with computer instructions stored thereon, wherein the computer instructions are used for causing a method for training sound source localization model, wherein the target detection method includes: obtaining a sample audio according to an audio signal including a wake-up word; extracting an audio feature of at least one audio frame in the sample audio, and marking a direction label and a mask label of the at least one audio frame; and training a neural network model by using the audio feature of the at least one audio frame and the direction label and the mask label of the at least one audio frame, to obtain a sound source localization model.

As can be seen from the above technical solutions, in this embodiment, after a sample audio is obtained according to an audio signal including a wake-up word, for at least one audio frame in the sample audio, an audio feature is extracted and a direction label and a mask label are marked, and then a sound source localization model is obtained by training by using the audio feature, the direction label and the mask label of the at least one audio frame, so as to enhance the training effect of the sound source localization model and improve the accuracy and the speed of the sound source localization model during sound source localization.

It should be understood that the content described in this part is neither intended to identify key or significant features of the embodiments of the present disclosure, nor intended to limit the scope of the present disclosure. Other features of the present disclosure will be made easier to understand through the following description.

### BRIEF DESCRIPTION OF DRAWINGS

The accompanying drawings are intended to provide a better understanding of the solutions and do not constitute a limitation on the present disclosure. In the drawings,

FIG. 1 is a schematic diagram according to a first embodiment of the present disclosure;

FIG. 2 is a schematic diagram according to a second embodiment of the present disclosure;

FIG. 3 is a schematic diagram according to a third embodiment of the present disclosure;

FIG. 4 is a schematic diagram according to a fourth embodiment of the present disclosure;

FIG. 5 is a schematic diagram according to a fifth embodiment of the present disclosure; and

FIG. 6 is a block diagram of an electronic device configured to perform a method for training sound source localization model and a sound source localization method according to embodiments of the present disclosure.

### DETAILED DESCRIPTION OF PREFERRED EMBODIMENTS

Exemplary embodiments of the present disclosure are illustrated below with reference to the accompanying drawings, which include various details of the present disclosure to facilitate understanding and should be considered only as exemplary. Therefore, those of ordinary skill in the art should be aware that various changes and modifications can be made to the embodiments described herein without departing from the scope and spirit of the present disclosure. Similarly, for clarity and simplicity, descriptions of well-known functions and structures are omitted in the following description.

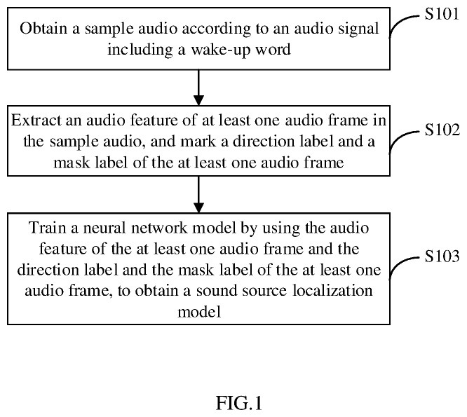

FIG. 1 is a schematic diagram according to a first embodiment of the present disclosure. As shown in FIG. 1, a method for training sound source localization model according to this embodiment includes the following steps.

In S101, a sample audio according to an audio signal including a wake-up word is obtained.

In S102, an audio feature of at least one audio frame in the sample audio is extracted, and a direction label and a mask label of the at least one audio frame are marked.

In S103, a neural network model is trained by using the audio feature of the at least one audio frame and the direction label and the mask label of the at least one audio frame, to obtain a sound source localization model.

In the method for training sound source localization model according to this embodiment, after a sample audio is obtained according to an audio signal including a wake-up word, for at least one audio frame in the sample audio, an audio feature is extracted and a direction label and a mask label are marked, and then a sound source localization model is obtained by training by using the audio feature, the direction label and the mask label of the at least one audio frame, so as to enhance a training effect of the sound source localization model and improve accuracy and a speed of the sound source localization model during sound source localization.

In this embodiment, when S101 is performed, an audio signal including a wake-up word is acquired first, and then the acquired audio signal is processed to obtain a sample audio. In this embodiment, if S101 is performed to acquire a plurality of audio signals including wake-up words, a plurality of sample audios may be obtained correspondingly.

Specifically, in this embodiment, if S101 is performed to obtain a sample audio according to an audio signal including a wake-up word, an optional implementation may involve: acquiring a word length of the wake-up word included in the audio signal; determining a target duration corresponding to the word length, which may be determined according to a correspondence between preset word lengths and target durations in this embodiment, for example, a target duration corresponding to a word length 4 may be 2 s, and a target duration corresponding to a word length 2 may be 1 s; and capturing an audio corresponding to the determined target duration from the audio signal as the sample audio.

In this embodiment, when S101 is performed to capture an audio corresponding to the determined target duration from the audio signal, the audio may be captured randomly or according to a preset position (such as a middle position, a start position, or an end position of the audio signal).

That is, in this embodiment, the sample audio is captured from the audio signal, so that the wake-up word being in different positions can be simulated, so as to improve the robustness of the sound source localization model trained based on the captured sample audio.

In this embodiment, after S101 is performed to obtain a sample audio, S102 is performed to extract an audio feature of at least one audio frame in the sample audio and mark a direction label and a mask label of the at least one audio frame. The at least one audio frame in this embodiment is all or some of the audio frames in the sample audio.

In this embodiment, the audio feature extracted by performing S102 is a Fast Fourier Transform (FFT) feature. In this embodiment, the direction label marked by performing S102 is configured for indicating an actual direction of the audio frame. The mask label marked by performing S102 is 1 or 0, configured for indicating whether the audio frame participates in calculation of a loss function value of a neural network model.

Specifically, in this embodiment, when S102 is performed to extract an audio feature of at least one audio frame in the sample audio, an optional implementation may involve: obtaining, for each audio frame in the at least one audio frame, an FFT feature of each channel of the audio frame; and extracting a real part and an imaginary part in the FFT feature of each channel respectively, and taking an extraction result as the audio feature of the audio frame.

For example, if the audio frame is a 3-channel signal, in this embodiment, after an FFT feature of each channel is obtained, a real part and an imaginary part in the FFT feature of each channel are extracted, and a 6-channel feature finally obtained is taken as the audio feature of the audio frame.

That is, in this embodiment, by extracting a real part and an imaginary part in the FFT feature, phase information can be retained completely without adding log spectral features including semantic information to the audio feature, thereby reducing an amount of calculation.

In this embodiment, when S102 is performed to mark a direction label of the at least one audio frame, an actual direction of each audio frame in the at least one audio frame may be determined, and then a value corresponding to a position of the actual direction in the direction label is marked as 1 and other positions are marked as 0.

For example, if preset directions are four directions of east, south, west and north, and if the actual direction of the audio frame is south, in this embodiment, S102 is performed to mark the direction label of the audio frame as (0, 1, 0, 0).

Specifically, in this embodiment, when S102 is performed to mark a mask label of the at least one audio frame, an optional implementation may involve: marking, for each audio frame in the at least one audio frame, a mask label of the audio frame as a preset label in a case where the audio frame is determined as an audio frame a preset number of frames preceding a wake-up word endpoint frame in the audio signal. In this embodiment, the preset label is 1, and the audio frame marked as the preset label participates in the calculation of the loss function of the neural network model.

The preset number of frames in this embodiment may be set according to an actual requirement. If the preset number of frames is 40, in this embodiment, S102 is performed to mark a mask label of the audio frame 40 frames preceding a wake-up word endpoint frame as the preset label.

That is, in this embodiment, by marking the mask label of the audio frame, local wake-up information can be weakened, so that the model can eliminate local interference during the training and pay more attention to direction information of the complete wake-up word.

In this embodiment, after S102 is performed to extract an audio feature of at least one audio frame in the sample audio and mark a direction label and a mask label of the at least one audio frame, S103 is performed to train a neural network model by using the audio feature of the at least one audio frame and the direction label and the mask label of the at least one audio frame, to obtain a sound source localization model.

In this embodiment, the neural network model trained by performing S103 consists of at least one convolutional network layer, at least one recurrent network layer and a fully connected layer that are sequentially connected. The convolutional network layer is configured for feature extraction. The convolutional network layer may be a MobileNet-based block. The recurrent network layer is configured for feature calculation. The recurrent network layer may be a Recurrent Neural Network (RNN)-based Gated Recurrent Unit (GRU). The recurrent network layer can predict direction information of a current audio frame according to an audio frame preceding the current audio frame in a memory unit. The fully connected layer is configured to predict a direction of the audio frame. The fully connected layer may be a Softmax layer.

Specifically, in this embodiment, when S103 is performed to train a neural network model by using the audio feature of the at least one audio frame and the direction label and the mask label of the at least one audio frame, to obtain a sound source localization model, an optional implementation may involve: inputting the audio feature of the at least one audio frame into the neural network model, to obtain a direction prediction result outputted by the neural network model for each audio frame in the at least one audio frame; calculating a loss function value according to the direction prediction result and the direction label of the audio frame in a case where the mask label of the audio frame is determined as a preset label; and adjusting parameters of the neural network model according to the calculated loss function value, until the neural network model converges, to obtain the sound source localization model.

That is, in this embodiment, when the neural network model is trained, an audio frame configured for parameter update can be selected based on a mask label of the audio frame, so that the neural network model can pay more attention to direction information of a complete wake-up word, thereby improving a training effect of the neural network model.

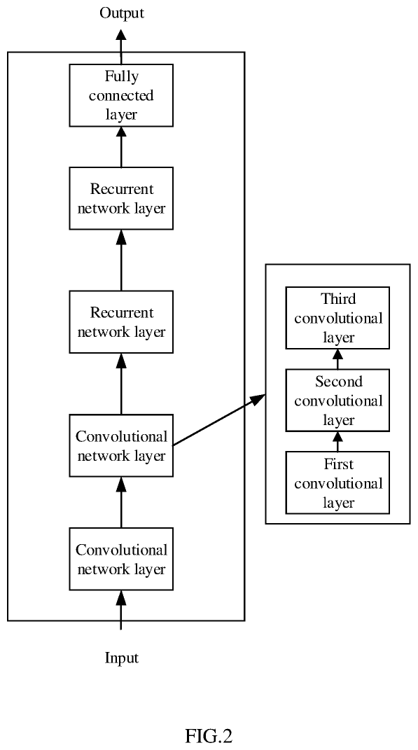

FIG. 2 is a schematic diagram according to a second embodiment of the present disclosure. As shown in FIG. 2, this embodiment shows a schematic structural diagram of a sound source localization model. The sound source localization model in FIG. 2 consists of two convolutional network layers (based on a MobileNet structure), two recurrent network layers (based on a GRU structure) and a fully connected layer, which ensures a small amount of calculation and can further ensure a more accurate localization effect. The convolutional network layer may include a first convolutional layer (with a convolutional kernel size of 1×1 and an activation function of Relu6), a second convolutional layer (with a convolutional kernel size of 3×3 deep convolution and an activation function of Relu6) and a third convolutional layer (with a convolutional kernel size of 1×1 and an activation function of Linear).

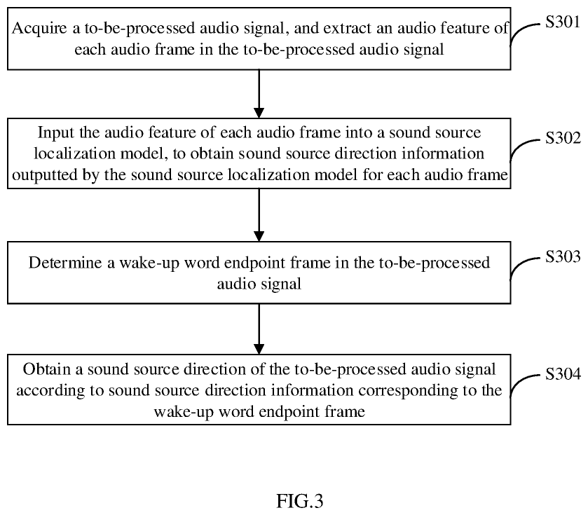

FIG. 3 is a schematic diagram according to a third embodiment of the present disclosure. As shown in FIG. 3, a sound source localization method according to this embodiment may specifically include the following steps.

In S301, a to-be-processed audio signal is acquired, and an audio feature of each audio frame in the to-be-processed audio signal is extracted.

In S302, the audio feature of each audio frame is inputted into a sound source localization model, to obtain sound source direction information outputted by the sound source localization model for each audio frame.

In S303, a wake-up word endpoint frame in the to-be-processed audio signal is determined.

In S304, a sound source direction of the to-be-processed audio signal is obtained according to sound source direction information corresponding to the wake-up word endpoint frame.

In the sound source localization method according to this embodiment, sound source direction information of each audio frame in a to-be-processed audio signal is obtained through a pre-trained sound source localization model, and then after a wake-up word endpoint frame in the to-be-processed audio signal is determined, a sound source direction of the to-be-processed audio signal may be obtained according to sound source direction information corresponding to the wake-up word endpoint frame, which can improve accuracy and a speed in the determination of the sound source direction and achieve a purpose of obtaining the sound source direction at the moment of wake-up, so as to improve timeliness in the determination of the sound source direction.

In this embodiment, when S301 is performed, an audio signal collected by an audio acquisition apparatus may be taken as the to-be-processed audio signal. The audio acquisition apparatus may be located in intelligent devices such as intelligent speakers, intelligent home appliances and intelligent vehicles.

In this embodiment, when S301 is performed to extract an audio feature of each audio frame in the to-be-processed audio signal, an optional implementation may involve: obtaining, for each audio frame, an FFT feature of each channel of the audio frame; and extracting a real part and an imaginary part in the FFT feature of each channel respectively, and taking an extraction result as the audio feature of the audio frame.

In this embodiment, after S301 is performed to extract an audio feature of each audio frame, S302 is performed to input the audio feature of each audio frame into a sound source localization model, to obtain sound source direction information outputted by the sound source localization model for each audio frame. In this embodiment, the sound source direction information obtained by performing S302 is configured for indicating a value of a probability that the audio frame is in a preset direction.

Since each audio frame corresponds to a timing sequence in the to-be-processed audio signal, in this embodiment, when S302 is performed, the audio feature of each audio frame may be sequentially inputted into the sound source localization model, and at least one recurrent network layer in the sound source localization model performs feature calculation in combination with states memorized in the memory unit, so as to obtain the sound source direction information outputted by the sound source localization model for each audio frame.

In this embodiment, when S302 is performed to obtain sound source direction information outputted by the sound source localization model for each audio frame, the following content may also be included. A time window of a preset size is provided. For example, the preset size is 2 s. The time window is configured for sliding on a plurality of audio frames (i.e., the to-be-processed audio signal). In a case where it is determined that a processing duration reaches the preset size, the memory unit of at least one recurrent network layer in the sound source localization model is cleared. The time window is moved back a preset distance on the plurality of audio frames, for example, a preset distance of 0.8 s. The sound source localization model processes audio frames in an overlapping part between the two time windows before and after the movement, to obtain sound source direction information of each audio frame. It is detected whether a wake-up word endpoint frame in the to-be-processed audio signal is determined, and if no, a step of determining whether the processing duration reaches a preset duration is performed, the process is cyclically performed until the wake-up word endpoint frame in the to-be-processed audio signal is determined.

That is, in this embodiment, memories of the sound source localization model may be further cleared and recalled by arranging a time window, so as to improve the real-time performance of the sound source direction information of each audio frame outputted by the sound source localization model, and ensure a memory duration of a memory unit of at least one recurrent network layer in the sound source localization model.

In this embodiment, after S302 is performed to obtain sound source direction information outputted by the sound source localization model for each audio frame, S303 is performed to determine a wake-up word endpoint frame in the to-be-processed audio signal. The wake-up word endpoint frame determined in this embodiment is an audio frame corresponding to a wake-up word end time.

Specifically, in this embodiment, when S303 is performed to determine a wake-up word endpoint frame in the to-be-processed audio signal, an optional implementation may involve: obtaining a wake-up word score of each audio frame according to the audio feature of the audio frame, which may be obtained by using a pre-trained wake-up model in this embodiment; and taking the last audio frame whose wake-up word score exceeds a preset score threshold as the wake-up word endpoint frame.

It may be understood that, in this embodiment, the prediction of the sound source direction information of the audio frame and the determination of the wake-up word endpoint frame in the to-be-processed audio signal may be performed at the same time.

In this embodiment, after S303 is performed to determine a wake-up word endpoint frame, S304 is performed to obtain a sound source direction of the to-be-processed audio signal according to sound source direction information corresponding to the wake-up word endpoint frame.

In this embodiment, when S304 is performed to obtain a sound source direction of the to-be-processed audio signal according to sound source direction information corresponding to the wake-up word endpoint frame, an optional implementation may involve: determining the sound source direction information corresponding to the wake-up word endpoint frame, that is, taking sound source direction information of the audio frame belonging to the wake-up word endpoint frame in the audio frames as the sound source direction information of the wake-up word endpoint frame; and taking a direction corresponding to a maximum value in the sound source direction information as the sound source direction of the to-be-processed audio signal.

For example, if preset directions are respectively east, south, west and north, and if the sound source direction information corresponding to the wake-up word endpoint frame determined by performing S303 in this embodiment is (0.2, 0.6, 0.1, 0.1), the south direction corresponding to the maximum value of 0.6 is taken as the sound source direction of the to-be-processed audio signal.

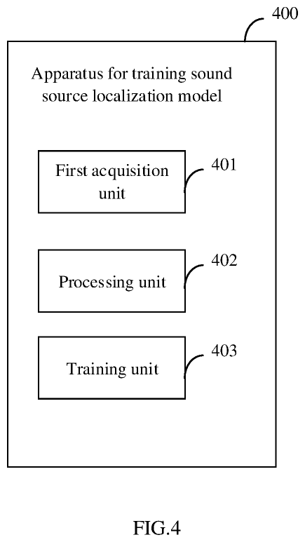

FIG. 4 is a schematic diagram according to a fourth embodiment of the present disclosure. As shown in FIG. 4, an apparatus 400 for training sound source localization model according to this embodiment includes:
a first acquisition unit 401 configured to obtain a sample audio according to an audio signal including a wake-up word;
a processing unit 402 configured to extract an audio feature of at least one audio frame in the sample audio, and mark a direction label and a mask label of the at least one audio frame; and
a training unit 403 configured to train a neural network model by using the audio feature of the at least one audio frame and the direction label and the mask label of the at least one audio frame, to obtain a sound source localization model.

The first acquisition unit 401 first acquires an audio signal including a wake-up word, and then process the acquired audio signal to obtain a sample audio. If the first acquisition unit 401 acquires a plurality of audio signals including wake-up words, a plurality of sample audios may be obtained correspondingly.

Specifically, when the first acquisition unit 401 obtains a sample audio according to an audio signal including a wake-up word, an optional implementation may involve: acquiring a word length of the wake-up word included in the audio signal; determining a target duration corresponding to the word length; and capturing an audio corresponding to the determined target duration from the audio signal as the sample audio.

When the first acquisition unit 401 captures an audio corresponding to the determined target duration from the audio signal, the audio may be captured randomly or according to a preset position (such as a middle position, a start position, or an end position of the audio signal).

That is, in this embodiment, the sample audio is captured from the audio signal, so that the wake-up word being in different positions of a time window can be simulated, so as to improve the robustness of the sound source localization model trained based on the captured sample audio.

In this embodiment, after the first acquisition unit 401 obtains the sample audio, the processing unit 402 extracts an audio feature of at least one audio frame in the sample audio, and marks a direction label and a mask label of the at least one audio frame.

The audio feature extracted by the processing unit 402 is an FFT feature. The direction label marked by the processing unit 402 is configured for indicating an actual direction of the audio frame. The mask label marked by the processing unit 402 is 1 or 0, configured for indicating whether the audio frame participates in calculation of a loss function value of a neural network model.

Specifically, when the processing unit 402 extracts an audio feature of at least one audio frame in the sample audio, an optional implementation may involve: obtaining, for each audio frame in the at least one audio frame, an FFT feature of each channel of the audio frame; and extracting a real part and an imaginary part in the FFT feature of each channel respectively, and taking an extraction result as the audio feature of the audio frame.

That is, in this embodiment, by extracting a real part and an imaginary part in the FFT feature, phase information can be retained completely without adding log spectral features including semantic information to the audio feature, thereby reducing an amount of calculation.

When the processing unit 402 marks a direction label of the at least one audio frame, an actual direction of each audio frame in the at least one audio frame may be determined, and then a value corresponding to a position of the actual direction in the direction label is marked as 1 and other positions are marked as 0.

Specifically, when the processing unit 402 marks a mask label of the at least one audio frame, an optional implementation may involve: marking, for each audio frame in the at least one audio frame, a mask label of the audio frame as a preset label in a case where the audio frame is determined as an audio frame a preset number of frames preceding a wake-up word endpoint frame in the audio signal. In this embodiment, the preset label is 1, and the audio frame marked as the preset label participates in the calculation of the loss function of the neural network model.

The preset number of frames in this embodiment may be set according to an actual requirement. If the preset number of frames is 40, the processing unit 402 marks a mask label of the audio frame 40 frames preceding a wake-up word endpoint frame as the preset label.

That is, in this embodiment, by marking the mask label of the audio frame, local wake-up information can be weakened, so that the model can eliminate local interference during the training and pay more attention to direction information of the complete wake-up word.

In this embodiment, after the processing unit 402 extracts an audio feature of at least one audio frame in the sample audio and marks a direction label and a mask label of the at least one audio frame, the training unit 403 trains a neural network model by using the audio feature of the at least one audio frame and the direction label and the mask label of the at least one audio frame, to obtain a sound source localization model.

The neural network model trained by the training unit 403 consists of at least one convolutional network layer, at least one recurrent network layer and a fully connected layer that are sequentially connected. The convolutional network layer is configured for feature extraction. The convolutional network layer may be a MobileNet-based block. The recurrent network layer is configured for feature calculation. The recurrent network layer may be an RNN-based GRU. The recurrent network layer can predict direction information of a current audio frame according to an audio frame preceding the current audio frame in a memory unit. The fully connected layer is configured to predict a direction of the audio frame. The fully connected layer may be a Softmax layer.

Specifically, when the training unit 403 trains a neural network model by using the audio feature of the at least one audio frame and the direction label and the mask label of the at least one audio frame, to obtain a sound source localization model, an optional implementation may involve: inputting the audio feature of the at least one audio frame into the neural network model, to obtain a direction prediction result outputted by the neural network model for each audio frame in the at least one audio frame; calculating a loss function value according to the direction prediction result and the direction label of the audio frame in a case where the mask label of the audio frame is determined as a preset label; and adjusting parameters of the neural network model according to the calculated loss function value, until the neural network model converges, to obtain the sound source localization model.

That is, in this embodiment, when the neural network model is trained, an audio frame configured for parameter update can be selected based on a mask label of the audio frame, so that the neural network model can pay more attention to direction information of a complete wake-up word, thereby improving a training effect of the neural network model.

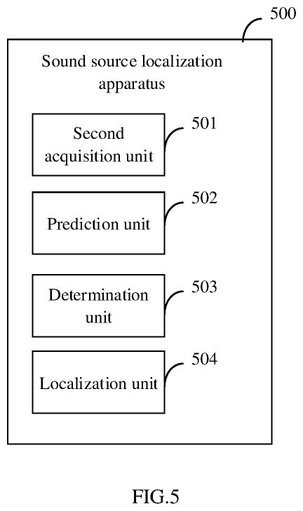

FIG. 5 is a schematic diagram according to a fifth embodiment of the present disclosure. As shown in FIG. 5, a sound source localization apparatus 500 according to this embodiment includes:
a second acquisition unit 501 configured to acquire a to-be-processed audio signal, and extract an audio feature of each audio frame in the to-be-processed audio signal;
a prediction unit 502 configured to input the audio feature of each audio frame into a sound source localization model, to obtain sound source direction information outputted by the sound source localization model for each audio frame;
a determination unit 503 configured to determine a wake-up word endpoint frame in the to-be-processed audio signal; and
a localization unit 504 configured to obtain a sound source direction of the to-be-processed audio signal according to sound source direction information corresponding to the wake-up word endpoint frame.

The second acquisition unit 501 may take an audio signal collected by an audio acquisition apparatus as the to-be-processed audio signal.

When the second acquisition unit 501 extracts an audio feature of each audio frame in the to-be-processed audio signal, an optional implementation may involve: obtaining, for each audio frame, an FFT feature of each channel of the audio frame; and extracting a real part and an imaginary part in the FFT feature of each channel respectively, and taking an extraction result as the audio feature of the audio frame.

In this embodiment, after the second acquisition unit 501 extracts an audio feature of each audio frame, the prediction unit 502 inputs the audio feature of each audio frame into a sound source localization model, to obtain sound source direction information outputted by the sound source localization model for each audio frame. The sound source direction information obtained by the prediction unit 502 is configured for indicating a value of a probability that the audio frame is in a preset direction.

Since each audio frame corresponds to a timing sequence in the to-be-processed audio signal, the prediction unit 502 may sequentially inputs the audio feature of each audio frame into the sound source localization model, and at least one recurrent network layer in the sound source localization model performs feature calculation in combination with states memorized in the memory unit, so as to obtain the sound source direction information outputted by the sound source localization model for each audio frame.

When the prediction unit 502 obtains sound source direction information outputted by the sound source localization model for each audio frame, the following content may also be included. A time window of a preset size is provided. In a case where it is determined that a processing duration reaches the preset size, the memory unit of at least one recurrent network layer in the sound source localization model is cleared. The time window is moved back a preset distance on the plurality of audio frames. The sound source localization model processes audio frames in an overlapping part between the two time windows before and after the movement, to obtain sound source direction information of each audio frame. It is detected whether a wake-up word endpoint frame in the to-be-processed audio signal is determined, and if no, a step of determining whether the processing duration reaches a preset duration is performed, the process is cyclically performed until the wake-up word endpoint frame in the to-be-processed audio signal is determined.

That is, in this embodiment, memories of the sound source localization model may be further cleared and recalled by arranging a time window, so as to improve the real-time performance of the sound source direction information of each audio frame outputted by the sound source localization model, and ensure a memory duration of a memory unit of at least one recurrent network layer in the sound source localization model.

In this embodiment, after the prediction unit 502 obtains sound source direction information outputted by the sound source localization model for each audio frame, the determination unit 503 determines a wake-up word endpoint frame in the to-be-processed audio signal. The wake-up word endpoint frame determined by the determination unit 503 is an audio frame corresponding to a wake-up word end time.

Specifically, when the determination unit 503 determines a wake-up word endpoint frame in the to-be-processed audio signal, an optional implementation may involve: obtaining a wake-up word score of each audio frame according to the audio feature of the audio frame; and taking the last audio frame whose wake-up word score exceeds a preset score threshold as the wake-up word endpoint frame.

In this embodiment, after the determination unit 503 determines a wake-up word endpoint frame, the localization unit 504 obtains a sound source direction of the to-be-processed audio signal according to sound source direction information corresponding to the wake-up word endpoint frame.

When the localization unit 504 obtains a sound source direction of the to-be-processed audio signal according to sound source direction information corresponding to the wake-up word endpoint frame, an optional implementation may involve: determining the sound source direction information corresponding to the wake-up word endpoint frame; and taking a direction corresponding to a maximum value in the sound source direction information as the sound source direction of the to-be-processed audio signal.

Acquisition, storage and application of users' personal information involved in the technical solutions of the present disclosure comply with relevant laws and regulations, and do not violate public order and moral.

According to embodiments of the present disclosure, the present disclosure further provides an electronic device, a readable storage medium and a computer program product.

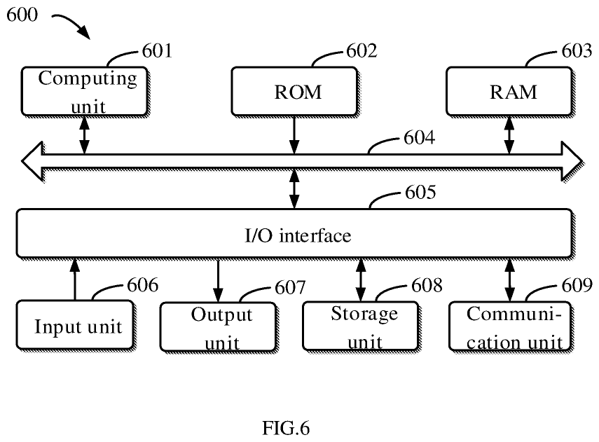

FIG. 6 is a block diagram of an electronic device configured to perform a method for training sound source localization model and a sound source localization method according to embodiments of the present disclosure. The electronic device is intended to represent various forms of digital computers, such as laptops, desktops, workbenches, personal digital assistants, servers, blade servers, mainframe computers and other suitable computing devices. The electronic device may further represent various forms of mobile devices, such as personal digital assistants, cellular phones, smart phones, wearable devices and other similar computing devices. The components, their connections and relationships, and their functions shown herein are examples only, and are not intended to limit the implementation of the present disclosure as described and/or required herein.

As shown in FIG. 6, the device 600 includes a computing unit 601, which may perform various suitable actions and processing according to a computer program stored in a read-only memory (ROM) 602 or a computer program loaded from a storage unit 608 into a random access memory (RAM) 603. The RAM 603 may also store various programs and data required to operate the device 600. The computing unit 601, the ROM 602 and the RAM 603 are connected to one another by a bus 604. An input/output (I/O) interface 605 may also be connected to the bus 604.

A plurality of components in the device 600 are connected to the I/O interface 605, including an input unit 606, such as a keyboard and a mouse; an output unit 607, such as various displays and speakers; a storage unit 608, such as disks and discs; and a communication unit 609, such as a network card, a modem and a wireless communication transceiver. The communication unit 609 allows the device 600 to exchange information/data with other devices over computer networks such as the Internet and/or various telecommunications networks.

The computing unit 601 may be a variety of general-purpose and/or special-purpose processing components with processing and computing capabilities. Some examples of the computing unit 601 include, but are not limited to, a central processing unit (CPU), a graphics processing unit (GPU), various artificial intelligence (AI) computing chips, various computing units that run machine learning model algorithms, a digital signal processor (DSP), and any appropriate processor, controller or microcontroller, etc. The computing unit 601 performs the methods and processing described above, such as the method for training sound source localization model and the sound source localization method. For example, in some embodiments, the method for training sound source localization model and the sound source localization method may be implemented as a computer software program that is tangibly embodied in a machine-readable medium, such as the storage unit 608.

In some embodiments, part or all of a computer program may be loaded and/or installed on the device 600 via the ROM 602 and/or the communication unit 609. One or more steps of the method for training sound source localization model and the sound source localization method described above may be performed when the computer program is loaded into the RAM 603 and executed by the computing unit 601. Alternatively, in other embodiments, the computing unit 601 may be configured to perform the method for training sound source localization model and the sound source localization method by any other appropriate means (for example, by means of firmware).

Various implementations of the systems and technologies disclosed herein can be realized in a digital electronic circuit system, an integrated circuit system, a field programmable gate array (FPGA), an application-specific integrated circuit (ASIC), an application-specific standard product (ASSP), a system on chip (SOC), a complex programmable logic device (CPLD), computer hardware, firmware, software, and/or combinations thereof. Such implementations may include implementation in one or more computer programs that are executable and/or interpretable on a programmable system including at least one programmable processor, which can be special or general purpose, configured to receive data and instructions from a storage system, at least one input apparatus, and at least one output apparatus, and to transmit data and instructions to the storage system, the at least one input apparatus, and the at least one output apparatus.

Program codes configured to implement the methods in the present disclosure may be written in any combination of one or more programming languages. Such program codes may be supplied to a processor or controller of a general-purpose computer, a special-purpose computer, or other programmable apparatus for training sound source localization model and sound source localization apparatus to enable the function/operation specified in the flowchart and/or block diagram to be implemented when the program codes are executed by the processor or controller. The program codes may be executed entirely on a machine, partially on a machine, partially on a machine and partially on a remote machine as a stand-alone package, or entirely on a remote machine or a server.

In the context of the present disclosure, machine-readable media may be tangible media which may include or store programs for use by or in conjunction with an instruction execution system, apparatus or device. The machine-readable media may be machine-readable signal media or machine-readable storage media. The machine-readable media may include, but are not limited to, electronic, magnetic, optical, electromagnetic, infrared, or semiconductor systems, apparatuses or devices, or any suitable combinations thereof. More specific examples of machine-readable storage media may include electrical connections based on one or more wires, a portable computer disk, a hard disk, an RAM, an ROM, an erasable programmable read only memory (EPROM or flash memory), an optical fiber, a compact disk read only memory (CD-ROM), an optical storage device, a magnetic storage device, or any suitable combination thereof.

To provide interaction with a user, the systems and technologies described here can be implemented on a computer. The computer has: a display apparatus (e.g., a cathode-ray tube (CRT) or a liquid crystal display (LCD) monitor) for displaying information to the user; and a keyboard and a pointing apparatus (e.g., a mouse or trackball) through which the user may provide input for the computer. Other kinds of apparatuses may also be configured to provide interaction with the user. For example, a feedback provided for the user may be any form of sensory feedback (e.g., visual, auditory, or tactile feedback); and input from the user may be received in any form (including sound input, voice input, or tactile input).

The systems and technologies described herein can be implemented in a computing system including background components (e.g., as a data server), or a computing system including middleware components (e.g., an application server), or a computing system including front-end components (e.g., a user computer with a graphical user interface or web browser through which the user can interact with the implementation mode of the systems and technologies described here), or a computing system including any combination of such background components, middleware components or front-end components. The components of the system can be connected to each other through any form or medium of digital data communication (e.g., a communication network). Examples of the communication network include: a local area network (LAN), a wide area network (WAN) and the Internet.

The computer system may include a client and a server. The client and the server are generally far away from each other and generally interact via the communication network. A relationship between the client and the server is generated through computer programs that run on a corresponding computer and have a client-server relationship with each other. The server may be a cloud server, also known as a cloud computing server or cloud host, which is a host product in the cloud computing service system to solve the problems of difficult management and weak business scalability in the traditional physical host and a Virtual Private Server (VPS). The server may also be a distributed system server, or a server combined with blockchain.

It should be understood that the steps can be reordered, added, or deleted using the various forms of processes shown above. For example, the steps described in the present disclosure may be executed in parallel or sequentially or in different sequences, provided that desired results of the technical solutions disclosed in the present disclosure are achieved, which is not limited herein.

The above specific implementations do not limit the extent of protection of the present disclosure. Those skilled in the art should understand that various modifications, combinations, sub-combinations, and replacements can be made according to design requirements and other factors. Any modifications, equivalent substitutions and improvements made within the spirit and principle of the present disclosure all should be included in the extent of protection of the present disclosure.

What is claimed is:

1. A method for training sound source localization model, comprising:
obtaining a sample audio according to an audio signal comprising a wake-up word;
extracting an audio feature of at least one audio frame in the sample audio, and marking a direction label and a mask label of the at least one audio frame; and
training a neural network model by using the audio feature of the at least one audio frame and the direction label and the mask label of the at least one audio frame, to obtain a sound source localization model.

2. The method according to claim 1, wherein the step of obtaining sample audio according to an audio signal comprising a wake-up word comprises:
acquiring a word length of the wake-up word comprised in the audio signal;
determining a target duration corresponding to the word length; and
capturing an audio corresponding to the target duration from the audio signal as the sample audio.

3. The method according to claim 1, wherein the step of extracting an audio feature of at least one audio frame in the sample audio comprises:
obtaining, for each audio frame in the at least one audio frame, a Fast Fourier Transform (FFT) feature of each channel of the audio frame; and
extracting a real part and an imaginary part in the FFT feature of each channel respectively, and taking an extraction result as the audio feature of the audio frame.

4. The method according to claim 1, wherein the step of marking a mask label of the at least one audio frame comprises:
marking, for each audio frame in the at least one audio frame, a mask label of the audio frame as a preset label in a case where the audio frame is determined as an audio frame a preset number of frames preceding a wake-up word endpoint frame in the audio signal.

5. The method according to claim 1, wherein the step of training a neural network model by using the audio feature of the at least one audio frame and the direction label and the mask label of the at least one audio frame, to obtain a sound source localization model comprises:
inputting the audio feature of the at least one audio frame into the neural network model, to obtain a direction prediction result outputted by the neural network model for each audio frame in the at least one audio frame;
calculating a loss function value according to the direction prediction result and the direction label of the audio frame in a case where the mask label of the audio frame is determined as a preset label; and
adjusting parameters of the neural network model according to the calculated loss function value, until the neural network model converges, to obtain the sound source localization model.

6. A sound source localization method, comprising:
acquiring a to-be-processed audio signal, and extracting an audio feature of each audio frame in the to-be-processed audio signal;
inputting the audio feature of each audio frame into a sound source localization model, to obtain sound source direction information outputted by the sound source localization model for each audio frame;
determining a wake-up word endpoint frame in the to-be-processed audio signal; and
obtaining a sound source direction of the to-be-processed audio signal according to sound source direction information corresponding to the wake-up word endpoint frame;
wherein the sound source localization model is pre-trained based on the method according to claim 1.

7. The method according to claim 6, wherein the step of extracting an audio feature of each audio frame in the to-be-processed audio signal comprises:
obtaining, for each audio frame, an FFT feature of each channel of the audio frame; and
extracting a real part and an imaginary part in the FFT feature of each channel respectively, and taking an extraction result as the audio feature of the audio frame.

8. The method according to claim 6, wherein the step of determining a wake-up word endpoint frame in the to-be-processed audio signal comprises:
obtaining a wake-up word score of each audio frame according to the audio feature of the audio frame; and
taking the last audio frame whose wake-up word score exceeds a preset score threshold as the wake-up word endpoint frame.

9. An electronic device, comprising:
at least one processor; and
a memory communicatively connected with the at least one processor;
wherein the memory stores instructions executable by the at least one processor, and the instructions are executed by the at least one processor to enable the at least one processor to perform a method for training sound source localization model, wherein the method comprises:
obtaining a sample audio according to an audio signal comprising a wake-up word;
extracting an audio feature of at least one audio frame in the sample audio, and marking a direction label and a mask label of the at least one audio frame; and
training a neural network model by using the audio feature of the at least one audio frame and the direction label and the mask label of the at least one audio frame, to obtain a sound source localization model.

10. The electronic device according to claim 9, wherein the step of obtaining sample audio according to an audio signal comprising a wake-up word comprises:
acquiring a word length of the wake-up word comprised in the audio signal;
determining a target duration corresponding to the word length; and
capturing an audio corresponding to the target duration from the audio signal as the sample audio.

11. The electronic device according to claim 9, wherein the step of extracting an audio feature of at least one audio frame in the sample audio comprises:
obtaining, for each audio frame in the at least one audio frame, an FFT feature of each channel of the audio frame; and
extracting a real part and an imaginary part in the FFT feature of each channel respectively, and taking an extraction result as the audio feature of the audio frame.

12. The electronic device according to claim 9, wherein the step of marking a mask label of the at least one audio frame comprises:
marking, for each audio frame in the at least one audio frame, a mask label of the audio frame as a preset label in a case where the audio frame is determined as an audio frame a preset number of frames preceding a wake-up word endpoint frame in the audio signal.

13. The electronic device according to claim 9, wherein the step of training a neural network model by using the audio feature of the at least one audio frame and the direction label and the mask label of the at least one audio frame, to obtain a sound source localization model comprises:
inputting the audio feature of the at least one audio frame into the neural network model, to obtain a direction prediction result outputted by the neural network model for each audio frame in the at least one audio frame;
calculating a loss function value according to the direction prediction result and the direction label of the audio frame in a case where the mask label of the audio frame is determined as a preset label; and
adjusting parameters of the neural network model according to the calculated loss function value, until the neural network model converges, to obtain the sound source localization model.

14. A non-transitory computer readable storage medium with computer instructions stored thereon, wherein the computer instructions are used for causing a method for training sound source localization model, wherein the target detection method comprises:
obtaining a sample audio according to an audio signal comprising a wake-up word;
extracting an audio feature of at least one audio frame in the sample audio, and marking a direction label and a mask label of the at least one audio frame; and
training a neural network model by using the audio feature of the at least one audio frame and the direction label and the mask label of the at least one audio frame, to obtain a sound source localization model.

15. The non-transitory computer readable storage medium according to claim 14, wherein the step of obtaining sample audio according to an audio signal comprising a wake-up word comprises:
acquiring a word length of the wake-up word comprised in the audio signal;
determining a target duration corresponding to the word length; and
capturing an audio corresponding to the target duration from the audio signal as the sample audio.

16. The non-transitory computer readable storage medium according to claim 14, wherein the step of extracting an audio feature of at least one audio frame in the sample audio comprises:
obtaining, for each audio frame in the at least one audio frame, a Fast Fourier Transform (FFT) feature of each channel of the audio frame; and
extracting a real part and an imaginary part in the FFT feature of each channel respectively, and taking an extraction result as the audio feature of the audio frame.

17. The non-transitory computer readable storage medium according to claim 14, wherein the step of marking a mask label of the at least one audio frame comprises:
marking, for each audio frame in the at least one audio frame, a mask label of the audio frame as a preset label in a case where the audio frame is determined as an audio frame a preset number of frames preceding a wake-up word endpoint frame in the audio signal.

18. The non-transitory computer readable storage medium according to claim 14, wherein the step of training a neural network model by using the audio feature of the at least one audio frame and the direction label and the mask label of the at least one audio frame, to obtain a sound source localization model comprises:
inputting the audio feature of the at least one audio frame into the neural network model, to obtain a direction prediction result outputted by the neural network model for each audio frame in the at least one audio frame;
calculating a loss function value according to the direction prediction result and the direction label of the audio frame in a case where the mask label of the audio frame is determined as a preset label; and
adjusting parameters of the neural network model according to the calculated loss function value, until the neural network model converges, to obtain the sound source localization model.
